(19) United States
(12) Patent Application Publication
(10) Pub. No.: US 2015/0371200 A1
(43) Pub. Date: Dec. 24, 2015

(54) METHOD AND SYSTEM FOR MICRO-ACCUMULATION OF FUNDS

(71) Applicants: King Hei Sin, Richmond (CA); Vanessa Liping Fan, Richmond (CA)

(72) Inventors: King Hei Sin, Richmond (CA); Vanessa Liping Fan, Richmond (CA)

(21) Appl. No.: 14/733,762

(22) Filed: Jun. 8, 2015

Related U.S. Application Data
(63) Continuation of application No. 14/310,087, filed on Jun. 20, 2014.

(51) Int. Cl. G06Q 20/10; G06Q 20/20; G06Q 40/06; G06Q 20/22

(52) U.S. Cl. CPC G06Q 20/10; G06Q 20/29; G06Q 20/20; G06Q 40/06

(57) ABSTRACT

The present invention includes a method embodiment for accumulation and dispensation of micro-accumulation funds. The method includes performing, by a micro-accumulation fund (“MAF”) system, the system including a user interface device, a data storage device, and a processor, the steps of: receiving point-of-sale information relating to a purchase made by a user; computing a round-off amount in accordance with a user-defined rounding value; and transferring the round-off amount to a holding account. The present invention is further directed toward embodiments including a system and a computer program stored on a non-transitory computer-readable medium.

### PRIORITY CLAIM

This application is a continuation-in-part of U.S. patent application Ser. No. 14/310,087, filed Jun. 20, 2014, the contents of which are incorporated herein by reference.

### BACKGROUND OF THE INVENTION

1. Field of the Invention

The present invention is directed toward a method and system for micro-accumulation and distribution of funds.

2. Description of the Related Art

Financial products, including credit cards, stored value cards, debit cards, and automated teller machine (“ATM”) cards, have long been popular products of paying for goods and services, both for physical, brick-and-mortar locations and virtual merchants. Thus, such products can be considered ubiquitous forms of payment. Similarly, many users of these financial products currently engage in endeavors such as donations to charity, financial investing, and accruing funds in various types of savings accounts. In addition, many more users of such financial products may have an interest in these sorts of endeavors, but neglect to do so due to the inconvenience of managing transfers to these accounts or to the mistaken belief that large sums are required when effecting a transfer.

Accordingly, it would be beneficial to provide a method relating to purchases made using e.g., the aforementioned financial products that facilitates the transfer of funds for distribution into various endeavors, such as investment, charity and savings. Such a method may provide for an extra user-defined amount to be automatically added based on a purchase amount, and subsequently transferred to a holding account. Alternatively, this extra amount may represent an additional, separate transaction charge. This extra amount may accrue across multiple purchases before being transferred, e.g., in bulk, to a desired destination such as charity, investment, savings, etc. Furthermore, it would be beneficial if the method were operable on a computer system accessible by a user via the Internet.

### SUMMARY

The present invention is directed toward a method for accumulation and disbursement of micro-accumulation funds. In at least one embodiment, the method comprises the performance of steps by a micro-accumulation fund system (“MAF system”). The MAF system may comprise a user interface device, a data storage device, and a processor. The steps may include receiving point-of-sale information relating to a purchase made by a user; computing a round-off amount in accordance with a user-defined rounding value; and transferring the round-off amount to a holding account. The point-of-sale information comprises a purchase amount.

Furthermore, in at least one embodiment, computing a round-off amount comprises calculating a value X that is a lowest multiple of the user-defined rounding value such that X is greater than or equal to the purchase amount. Computing a round-off amount also comprises subtracting the purchase amount from X to yield the round-off amount.

Round-off amounts may be transferred to a holding account, where they may accumulate until transferred to a user's chosen destination. Examples of destinations include but are not limited to charity accounts, investment accounts, betting-investment accounts (such as for use with betting-related activities), bank accounts, as well as for withdrawal for an individual beneficiary, transfer to an account located overseas or in a local financial institution, transfer/storage in an individual's financial product such as a credit card, stored value card, Internet payment system (e.g., PayPal, Alipay, ApplePay, Google wallet), or the like; disbursement in the form of currency, including crypto-currency; or for use in subsequent purchases including for virtual checkout services. Transfers to a destination may be accomplished upon a user-initiated event, e.g., upon some action taken on the part of the user, or may be done pursuant to an automatic or regularly occurring, user-defined schedule, such as on a particular date of the month, day of the week, or the like. In some embodiments, the transfer from the holding account to the destination is conditioned upon the occurrence of some event, such as when the amount of money in the holding account exceeds some threshold value.

The described micro-accumulation techniques may be deployed in different contexts and/or combined with various other techniques for aggregating donations, investment funds, or the like. For example, the micro-accumulation techniques may be employed to aggregate funds for entry into hedge fund investments, betting portfolios, or donation collection. One embodiment combines micro-accumulation with a multi-level tree process for collecting donations for charitable purposes.

The present invention may also be directed toward system embodiments and/or embodiments including computer program segments stored on non-transitory computer readable media.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of a MAF system according to an embodiment of the present invention.

FIG. 2 is a schematic representation of a fund management system according to an embodiment of the present invention.

FIG. 3 is a schematic representation of a method according to an embodiment of the present invention.

FIG. 4 is a schematic representation of a method of calculating a round-off amount in relation to a rounding value and a transaction amount in accordance with an embodiment of the present invention.

FIG. 5 is a schematic representation of a micro-accumulation investment fund process performed by an example embodiment.

FIG. 6 is a schematic representation of a micro-accumulation betting fund process performed by an example embodiment.

FIG. 7 a schematic representation of a micro-accumulation global lotto process performed by an example embodiment.

FIG. 8 is a schematic representation of an example of a multi-level donation aggregation process according to an example embodiment.

FIG. 9 is a schematic representation of a micro-accumulation multi-level donation aggregation process performed by an example embodiment.

FIG. 10 is a flow diagram of a generalized micro-accumulation process according to an example embodiment.

FIGS. 11A and 11B are flow diagrams of holding account fund accumulation processes according to an example embodiment.

Like reference numerals refer to like parts throughout the several views of the drawings.

### DETAILED DESCRIPTION OF THE PREFERRED EMBODIMENT

As represented in the accompanying drawings, the present invention is generally directed to a method and system for micro-accumulation of funds. Generally speaking, users of the present invention may include individual persons, companies, and associations.

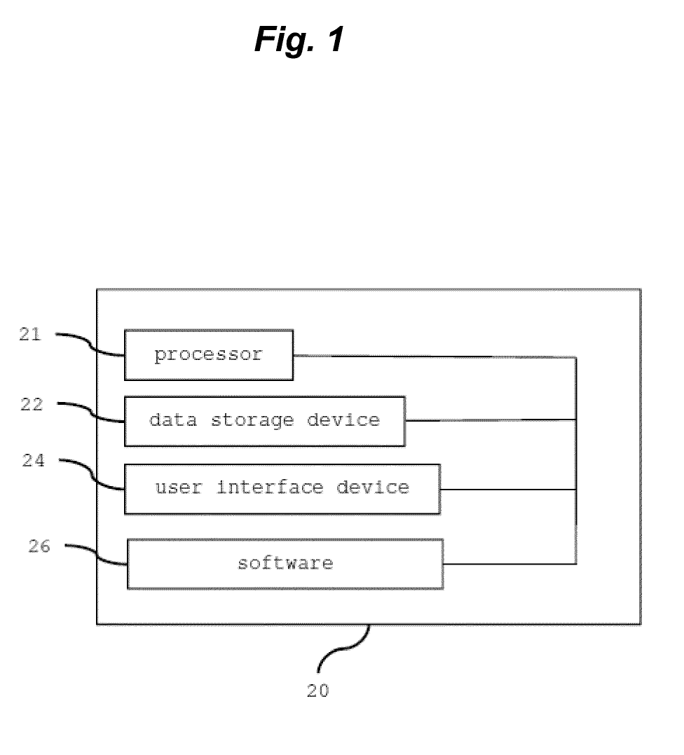

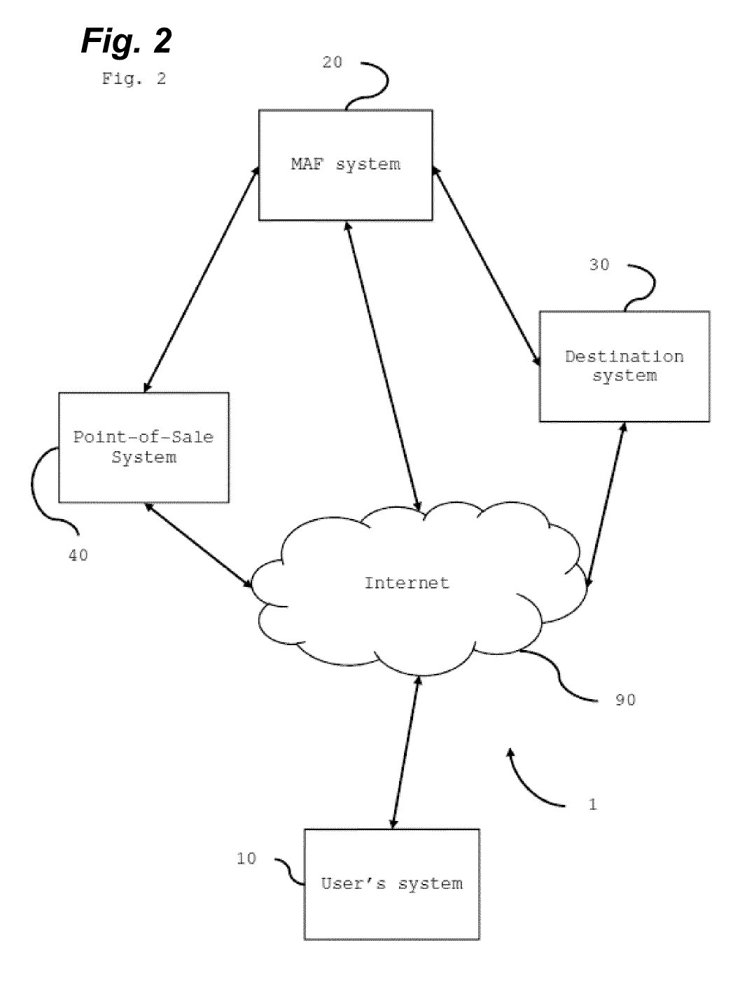

With primary reference to FIG. 2, a method embodiment of the present invention (which will be discussed in detail below) is operable on a fund management system, an example of which is generally indicated as 1. The fund management system 1 in at least one embodiment comprises a micro-accumulation fund system (hereinafter “MAF system”) 20. With reference to FIG. 1, The MAF system 20 may comprise a computer server, including a user interface device 24, processor 21, and data storage device 22, as well as software 26 operable thereon. The software 26 may comprise computer programming segments written in any suitable programming language, including for presentation and or execution by the MAF system 20 and/or a user's system 10. The MAF server may also comprise the necessary hardware and/or software to provide for interconnectivity with the user's system, such as via the Internet utilizing applicable protocols.

The user's system 10 may be a device employed by user to interact with the MAF system 20 and its features, as are also discussed below. Examples of user's systems 10 include any suitable web-accessible devices. In at least one embodiment, users may interact with the MAF system 20 by way of a website accessible by and displayed upon a user's system 10, such as through a web browser or other application, such as a mobile application.

In addition, the fund management system 1 may comprise a destination system 30, such as a third-party server. The destination system 30 may be a computer server, and includes but is not limited to any system as may be suitable for use by a financial institution. The MAF system 20 and the destination system 30 may be in direct communication or may be in communication through a network, such as the Internet 90.

Further, the fund management system 1 in at least one embodiment comprises a point-of-sale system 40. The point-of-sale system 40 provides to the MAF system 20 information relating to a user's purchases, as is further discussed below. The point-of-sale system 40 may comprise retailers of goods and services and/or a credit/debit card transaction processing system, card-reader hardware, a user's financial institution's system, or the like. Thus, the point-of-sale system 40 may comprise computer systems, networks, and the like. The MAF system 20 may communicate directly with the point-of-sale system 40 and/or the two may communicate through a network, such as the Internet 90. Accordingly, the point-of-sale system 40 may also broadly include transaction processing systems related to processing of credit cards, debit cards, automated teller machine (“ATM”) cards, and/or stored-value cards, etc. as well as banking systems facilitating such financial products.

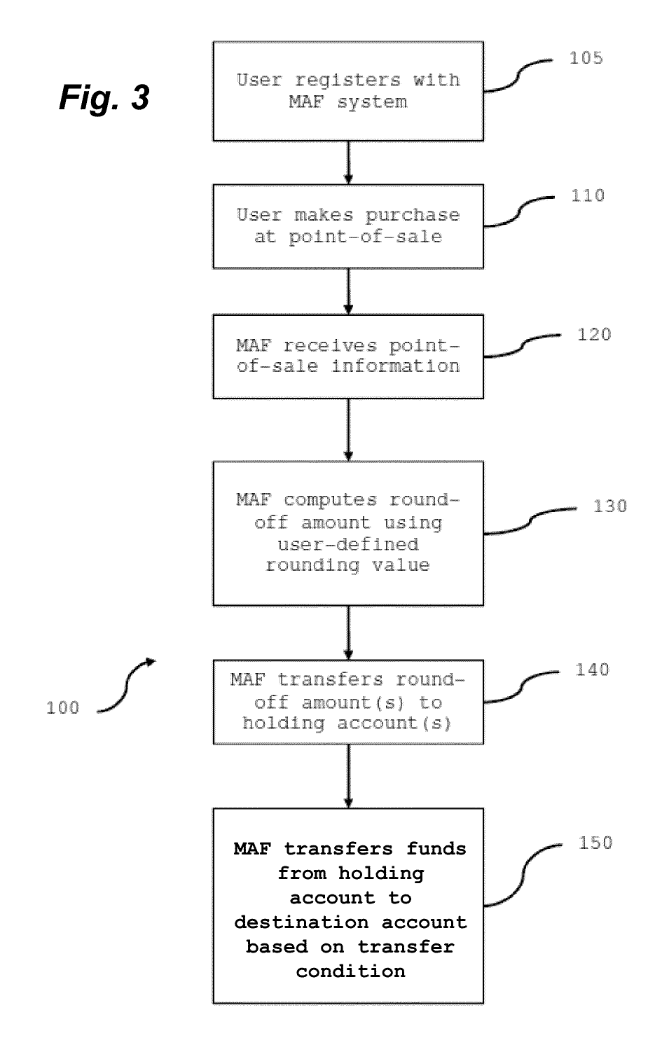

Turning now to FIG. 3, an example embodiment of a method 100 of the present invention is provided. A user may register with the MAF system, as indicated at 105. Such registration may include providing, by the user to the MAF system, of a user name, password, and financial information. Financial information may include, for example, information pertaining to an individual's financial product, such as a credit, debit, ATM card, stored-value card, Internet payment system (e.g., PayPal), or the like. Financial information may further include information pertaining to a user's financial accounts, such as a user's login name and password for a financial institution's website. Such financial information may be provided to facilitate withdrawal and deposit of funds according to operation of various steps of the method as discussed below.

In at least one embodiment, a user may then make a purchase at a point-of-sale, as indicated at 110. A point-of-sale may include any place, whether physical or virtual, where a user may make a purchase, such as brick-and-mortar as well as online retailers of goods and services.

In at least one embodiment, following the user's purchase, the MAF system receives point-of-sale information, as indicated at 120. The MAF system receives payment information from the point-of-sale system, which may include the physical and/or virtual seller of a good or service as well as the attendant payment processing system(s). The MAF system in at least one embodiment comprises card-reader hardware to facilitate the MAF system's acquiring of point-of-sale information. The payment information includes, at a minimum, a purchase amount.

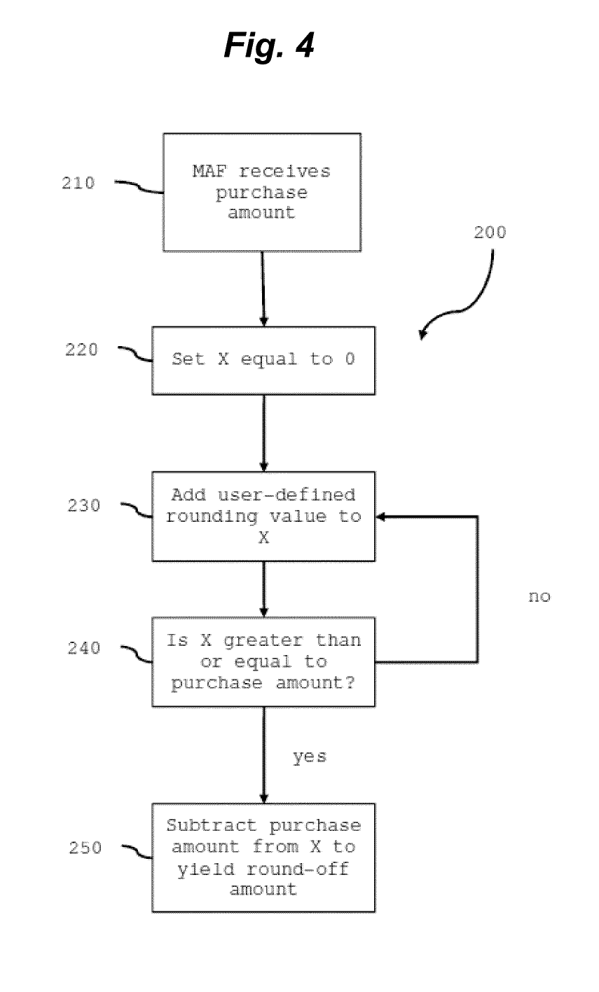

In at least one embodiment, the MAF system computes a “round-off” amount in accordance with a user-defined “rounding value,” as indicated at 130. The relatedness of the round-off and rounding value may be clarified with reference to FIG. 4, which depicts one embodiment of a method 200 of calculating a round-off amount in accordance with a rounding value. A round-off amount refers to an amount in addition to the total purchase amount to be charged to the user's account or registered financial product, e.g., a credit card, debit card, ATM card, and/or stored value card, for a particular good and/or service. This additional round-off amount is determined in conjunction with a user-defined rounding value. In at least one embodiment, the round off amount is a separate transaction charged to the user's account distinct but correlating to the transaction representing the charge for the total purchase amount for a particular good and/or service. Accordingly, the user's account will reflect two transactions in such an embodiment.

A rounding value, including but not limited to $1.00, $2.00, $5.00, and $10.00, may be selected from a list of pre-determined options presented to a user, or may be determined by the user, such as by typing a numerical value in a text box, such as when interacting with the MAF system 20 through a web-based interface. In at least one embodiment, the user may enter, such as into a text box, and/or select a rounding value, such as from an array of predetermined options, that is to be automatically applied to future purchases. In other embodiments, the user may select a rounding amount on a per-purchase basis, allowing for each purchase to be potentially calculated in conjunction with a different rounding amount. The role of a rounding value in various embodiments of the present invention will be discussed below. Briefly, however, a rounding value is at least partially determinative of an amount that is to be added to a user's total purchase and subsequently transferred to the user's holding account. Alternatively, in at least one embodiment separate transactions are made: one for the total amount and one for the rounding value.

With reference to FIG. 4, an embodiment of a method 200 of calculating a round-off amount in accordance with a rounding value is provided. A purchase amount is received by the MAF system, as at 210, and an arbitrary variable X is initialized as equal to 0, as at 220. The user-defined rounding value is then repeatedly added to X until X is greater than or equal to the purchase amount, as indicated at 230 and 240. Accordingly, by way of repetitive addition, X is now a “multiple” of the rounding value. When X is greater than or equal to the purchase amount, the purchase amount is subtracted from X. X is now equal to the round-off amount, as at 250.

To provide a numerical example of the above method 200, a purchase amount of $11.50 and a rounding value of $5.00 is considered. X is set to 0. Then $5.00 (the rounding value) is added to X. Since X equals $5.00 and is less than $11.50, $5.00 (the rounding value) is again added to X. Since X equals $10.00 and is still less than $11.50, $5.00 (the rounding value) is again added to X. Now, X=$15.00, which is the lowest multiple of the rounding value, $5.00, that is greater than or equal to the purchase amount, $11.50. Having calculated X, the MAF system now subtracts the purchase amount of $11.50 from X. Subtracting $11.50 from $15.00 yields a round-off amount of $3.50.

The foregoing method of computing a round-off amount is but one example for illustrative purposes, and it should thus be appreciated that other embodiments of the present invention may implement alternative methods.

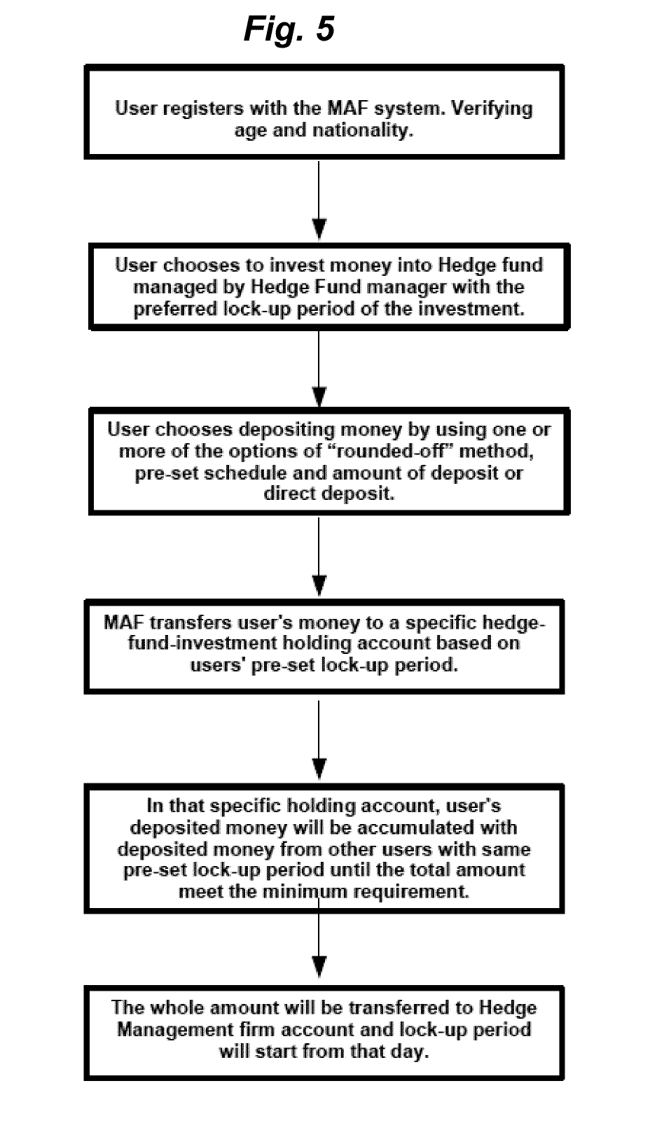

Returning to FIG. 3, the method 100 in at least one embodiment comprises transferring the round-off amount to a holding account 140. The holding account may be operated on or by the MAF system. Examples of holding accounts include but are not limited to trust accounts and escrow accounts. In some embodiments described below (e.g., FIGS. 5-10), the holding account may include funds from other users that have expressed a desire to invest in a similar destination or financial product. As described further below, by pooling contributions from multiple users, users can access financial products that would otherwise be unavailable (e.g., due to wealth or income requirements), share risk, and obtain other benefits.

In at least one embodiment, funds in the holding account accumulate until they are transferred, based on a transfer condition or event, to a destination account 150. Destination accounts, managed and/or located on destination systems, are selected by the user as the chosen destination for a transfer of at least some portion of the user's funds in the holding account. Examples of destination accounts may include charities, investment accounts, and a user's bank account. A further example includes betting-investment accounts, including those managed by a betting portfolio manager, who may be tasked with monitoring bets across various sports, venues, locales, or the like. The transfer may occur as a one-time, user-initiated event, such as a user's selection to initiate an immediate transfer or a transfer on a predetermined date and/or time.

As noted, the transfer from holding account to destination account may be performed by the MAF system based on a transfer condition or event. Various conditions are contemplated. For example, the transfer condition may be when the amount in the holding account meets or exceeds a predetermined threshold amount. In some cases, the destination account may have associated minimum funding requirements. For example, a hedge fund may require a minimum investment of $200,000. Another condition may be the requirement that a minimum number of distinct users have contributed to the holding account. Such a condition would facilitate risk sharing. Multiple conditions may be combined in some embodiments, such that multiple conditions must be true for the transfer to occur.

Other conditions may be based on time. For example, the transfer may also be set by the user to recur automatically according to a pre-determined schedule, such as weekly, monthly, every Monday, the last day of every month, or the like. Further, in at least one embodiment, a user may select multiple predetermined transfers. Further, in at least one embodiment, a user may withdraw funds from the holding account, such as in the form of currency or crypto-currency such as BitCoin or LiteCoin. In an alternative embodiment, a user may use funds in the holding account as a means of paying when interacting with virtual payment processors, such as Google Checkout or Paypal. A user may also withdraw funds for an individual beneficiary, transfer to an account located overseas or in a local financial institution, transfer/storage in an individual's financial product such as a credit card, ATM card, stored value card, and the like.

Furthermore, and with reference again to FIG. 2, in at least one embodiment the MAF system 20 may be configured to transfer an amount from a point-of-sale system 40 to a holding account associated with the MAF system 20, such as funds from a user's card to the holding account. This may be applicable in such case where a point-of-sale system 40 is a bank account, credit card, or other financial product such as those previously described. The MAF system 20 causes the user's account associated with the point-of-sale system 40 to be charged, debited, withdrawn, etc. a “direct transfer” amount, which is then deposited in the user's holding account associated with the MAF system 20. This “direct transfer” may be initiated upon a user's prompting, or may be set to occur according to a user-defined schedule, such as on a particular date of the month, day of the week, or the like. After accruing in the holding account of the MAF system 20, the “direct transfer” funds may be transferred to an account associated with a destination system 30 and/or withdrawn in accordance with the foregoing description.

The present invention may also be directed to an embodiment in the form of a computer program for carrying out the various steps of the method 100 of the accompanying figures. Accordingly, the computer program may comprise at least one code segment directed to at least one embodiment of the present invention. As used herein, “code segment” in the singular and “code segments” in the plural are interchangeable. The at least one code segment defines instructions for operation by a processor of a computer, causing the processor to practice a method embodiment of the present invention. Thus, the computer program may be stored on a non-transitory computer readable medium for execution by a computer system, such as by at least one processor thereof. Thus, the computer program may be deployed on a disk, memory device, or the like, and may be coded thereon in any suitable programming language or languages for installation and/or operation by any suitable computer system and associated operating system or systems as required.

### Applications and Enhancements of the Micro-Accumulation Techniques

In the following, a number of specific applications and enhancements of the above-described micro-accumulation and related techniques are described.

Micro-Accumulation for Hedge Fund Investment

Hedge fund investment is known to be exclusive to wealthy individuals. For example, a person needs to have a net worth of more than $1 million or an income of at least $200,000 over the last two years to be “accredited” for hedge fund investment. The requirement may be much higher for specific, high-profile hedge funds. Some hedge funds have been able to outperform market rates of return by using a variety of non-traditional strategies to try to offset risk. Unfortunately, because of the income and/or wealth requirements, access to hedge funds is foreclosed to the substantial majority of investors.

To address these limitations, one embodiment provides techniques for accumulating investments of multiple users into an amount that is large enough to qualify for hedge fund investment. The MAF system will provide an introduction or access to different world-wide hedge fund management firms or managers, with their recently performance reports and their minimum fund requirement and “lock-up” period. The lock-up period is a term during which a user's funds are available to the hedge fund for investment but not available to the user for withdrawal.

FIG. 5 is a flow diagram of a micro-accumulation investment fund process performed by an example embodiment. A user can use the MAP system to choose which hedge fund management firms to manage his/her investment and their preferred “lock-up” period, such as terms of three months, six months, a year, or the like. A user can deposit their money by employing the round-off methods described above with respect to transactions performed with credit cards, debit cards, automated teller machine(“ATM”) cards, stored-value cards, Internet payment systems (e.g., Paypal, Alipay, ApplePay, Google wallet), or the like.

Alternatively, or in addition, the user can deposit money by using a pre-set schedule and amount of deposit from credit cards, debit cards, automated teller machine(“ATM”) cards, and/or stored-value cards, Internet payment systems (e.g., Paypal, Alipay, ApplePay, Google wallet), or the like. For example the user may deposit $5.00 through Paypal every Monday, $2.50 from credit cards every last day of months, and so on.

Alternatively, or in addition, the user can deposit money using direct deposit, such as via credit cards, debit cards, automated teller machine(“ATM”) cards, and/or stored-value cards, Internet payment systems (e.g., Paypal, Alipay, ApplePay, Google wallet), or the like.

Based on the user's choices of management firm and lock-up period, the user's deposited money will be transferred to the specific holding account accumulating with other users having the same choices. During the accumulating period, the user has the option to withdraw their money from the holding account with no time restriction.

Once the amount in the holding account is accumulated to the target number, the entire amount in the holding account will be invested into the selected hedge fund. Once the money is transferred to the hedge fund, the lock-up period begins to run, meaning that the user must wait for the specified time period before accessing the funds.

The user is entitled to a share of the funds transferred to the hedge fund based on the pro-rata share of that user in the holding account at the time of transfer to the hedge fund. For example, if a given user held 10% of the funds in the holding account, that user would be entitled to 10% of the proceeds of the hedge fund account at the end of the lock-up period.

Micro-Accumulation for Betting Portfolio Investment

In this embodiment, the MAF system provides an introduction to and selection of various betting portfolio managers, each having an area of specialization, such as horse racing, football games, or the like. The MAF system will provide mechanisms for tracking and presenting performance information, in order to aid users in selecting a betting portfolio manager.

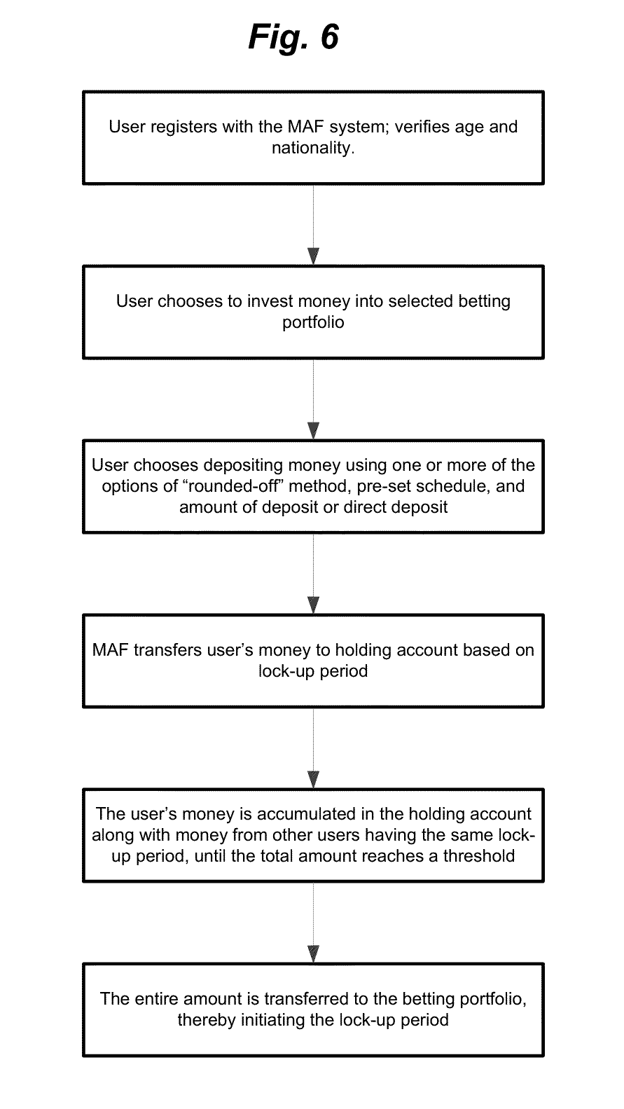

FIG. 6 is a flow diagram of a micro-accumulation betting fund process performed by an example embodiment. This embodiment provides a process that is similar to that of FIG. 5, except modified to select and direct funds to a betting portfolio manager instead of a hedge fund. In particular, after registering, the user can select a betting portfolio manager, based on factors such as performance, betting type, lock-up period, and the like. Then, the user chooses one or more money accumulation techniques, such as those described above with respect to micro-accumulation for hedge fund investment. Next, the user's money is transferred to a holding account that accumulates money for other users having the same lock-up period. The money is accumulated in the holding account until a threshold amount (e.g., the minimum required by the betting portfolio manager) is met. At that time, the money in the holding account is transferred to the betting portfolio, thereby initiating the lock-up period.

Global Lotto

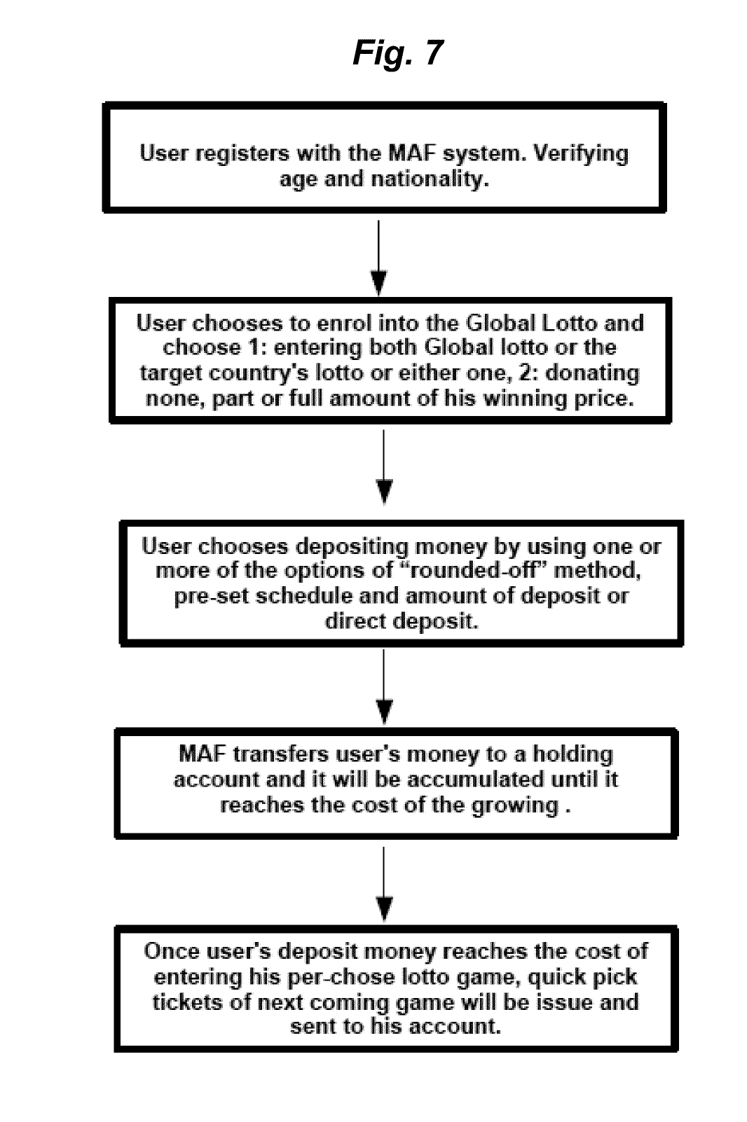

FIG. 7 is a flow diagram of a micro-accumulation global lotto process performed by an example embodiment. In this embodiment, the MAF system facilitates a global lotto system. This system enables users to access lotto and related games without geographic limitations.

In one example embodiment, the MAF system allows a user (player) to enter two distinct but related lotto games at once: (1) a game managed by the MAF system and (2) an underlying game in a target country. The first game (managed by the MAF system) tracks the underlying game in the target country, such as Canada “649”, USA “Lotto” or UK “Euromillion”, or the like, which will be selected by the system. The target country will be changed from time to time, with advance notice to clients, such as monthly, seasonally, or even yearly. For the second game, the MAF system purchases lotto tickets in the underlying game, based on contributions for players. Thus, each player has access to two distinct jackpots: (1) the jackpot managed by the MAF system for the first game and (2) the jackpot of the underlying game. A winning number in the underlying game is a winning number in the MAF-managed game.

The user has the option to donate part or full of his winning prize to charity. Choices of charity will be provided by the system based on the global incidents happening at that time, such as earthquakes, flooding, fire, or the like. In some embodiments, the user can decide to enter either or both of the games. In some embodiments, the MAF system will also donate a portion (e.g., 40%) of the sales for the MAF-managed game to one or more charities, based in global incidents, crises, or the like.

The user can choose from one or more methods of funding in order to fund the game, such as via round-off methods, direct deposit, scheduled deposit, or the like, as discussed with respect to the hedge fund investment embodiment described above.

From set amount of dollar from the system, such as US$4.00, the MAF system will purchase two “quick pick” tickets (e.g., tickets with randomly selected numbers) for the user. The quick pick numbers of both tickets will be the same. One ticket is for the target country's lotto game and the other ticket is for the Global Lotto game. Client can decide either entering both games or just one of two. Also, the client can preset to donate part or full of his winning lotto to the charity they want.

In the context of micro-accumulation, the MAF system can share risks and rewards using the techniques described herein. For example, when the pool of funds in the holding account reaches a predetermined threshold (e.g., the price of a single lotto ticket, the price of a batch of lotto tickets) the MAF system will purchase the corresponding number of tickets. Typically, multiple users will have contributed funds to the holding account, meaning that should the MAF system purchase a ticket with a winning number, multiple users will share in the reward. Also, the MAF system can require a minimum number of users as a condition that triggers the purchase of tickets, thereby encouraging widespread utilization of the system, and possibly also large volume ticket purchases, thereby increasing the chances of purchasing a winning ticket.

Some embodiments perform the global lotto process as follows. The MAF system selects a first lotto game, the first lotto game administered in a target country. The MAF system then establishes and manages a second lotto game that tracks rules and numbers drawn in the first lotto game. The MAF system collects funds in a holding account as described herein. The MAF system then, upon occurrence of a transfer condition (e.g., minimum funding level reached, minimum number of users reached), to a destination account, a portion of which is used to purchase tickets in the first game. A portion of the destination account is retained to fund the second game. Purchasing a ticket in the first game means purchasing an actual ticket in the underlying country game. In the second game, there is not ticket to be purchased, because the ticket for the first game operates as a ticket for the second game. Then, when one of the tickets purchased in the first lotto game is a winning ticket, the MAF system distributes winnings received from the first lotto game to the users. In addition, the MAF system makes a payout from the remaining funds in the destination account, reflecting that the winning ticket is also a winner in the second game.

Donation Systems and Methods

In some embodiments, the described micro-accumulation methods may be combined with techniques for accumulating or aggregating donations for charity purposes. The donation accumulation techniques include a multi-level donation structure that can be used by users to accomplish their charity-related desires with assistance from other users. The technique relies on a structure known as a “make a wish tree,” or a “donation tree.”

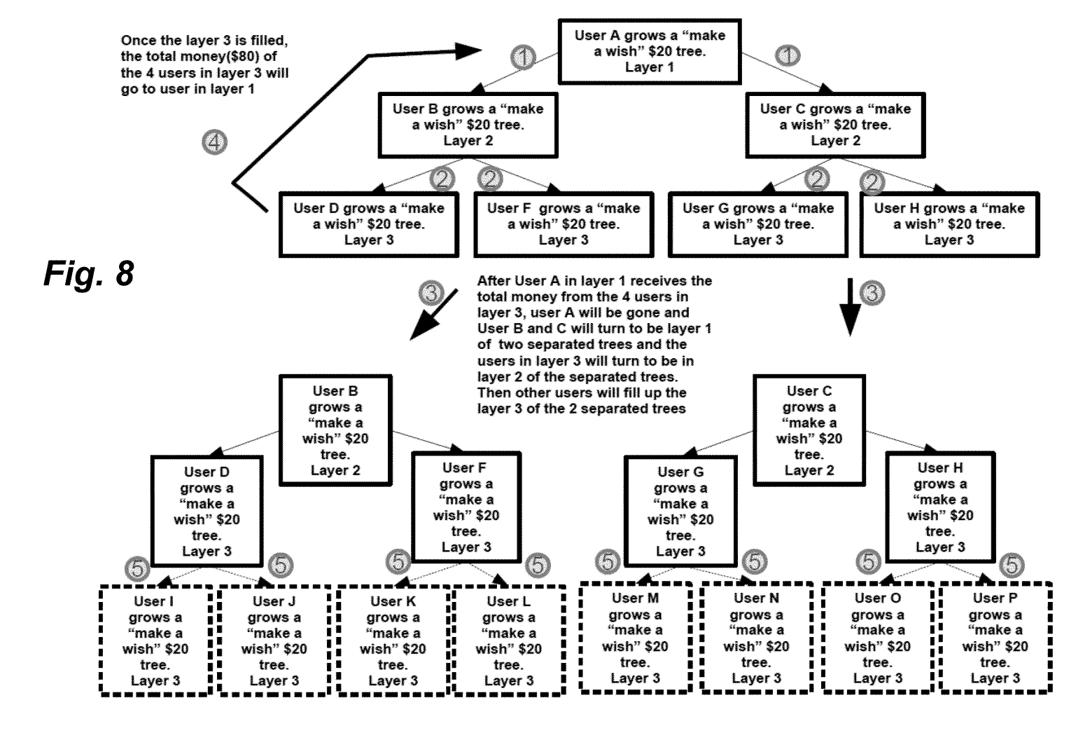

FIG. 8 illustrates an example of a multi-level donation aggregation process according to an example embodiment. As shown in FIG. 8, each donation tree includes three levels of structure. Other embodiments may include a greater or lesser number of levels. The first user to make a wish always begins at the first layer of the donation tree. In the described embodiment, there are three layers to the donation tree. In order to for the first user to fulfill his/her wish, he/she is required to “plant” (e.g., initiate, start) a tree as the first layer of the tree pyramid, and find two new users to plant two branches at the second layer of the tree pyramid. The entry requirement for the first user to make a wish is to plant a tree of a value (e.g., $20, $50 or $100). Once the first user has decided the value of his/her tree, he/she will plant it to become the first layer of his/her tree pyramid. He/she then needs to find or invite users to plant the same value of trees at the second layer through verbal, email, or any social media applications. Users from the second layer will also need to find new users to fill the third layer by planting the same value of trees. In other words, all users from three layers have to plant the same value of tree. First user owns one tree pyramid of three layers. When new users are filled for second and third layer, first user can then collect the value of the trees planted by users of the third layer to help fulfill his/her goal or wish.

Suppose for example that user A of FIG. 8 wishes to donate $80 to a hospital. User A can enroll into a tree pyramid and make herself the first layer and plant a $20 donation tree. In some embodiments, the user is required to add “fertilizer,” which is a service charge imposed by the MAF system. There fertilizer amount may be an amount determined to cover the costs of operating the MAF system, or it may be a higher amount, thereby enabling the operator of the MAF system to obtain a profit. In other embodiments, no service charge is assessed. In this example, the user provides $2 as fertilizer. The user can choose from the following methods of funding in order to fund the portfolio, such as via round-off methods, direct deposit, scheduled deposit, or the like, as discussed with respect to the hedge fund investment embodiment described above.

After user A has saved or collected enough money for planting her first tree, she needs to broadcast her wish and find new users (e.g., through face-to-face communication, the system website, Facebook, email, or any other social network applications, etc.) to join her second layer of her tree pyramid. In FIG. 8, the new users are users B and C. Anyone who wants to plant a tree of the same value as user A's will automatically be put into user A's tree pyramid as long as there is a vacancy in the second layer.

Each of these two users (B and C) who grow the tree branch on second layers of user A's tree only needs to do the same things as user A did: submitting $20 for planting and $2 for fertilizer, broadcasting their own wishes, and asking two friends to help. As with user A's situation, anyone who wants to make a wish and plant a tree of the same value as theirs will automatically be put into the vacancy of the third layer.

Eventually, users B and C each find two other users to fill up the four leaves of third layer of user A's tree. These users are D, F, G, and H. At this time, the money collected in the third layer goes to user A. Then, user A will have her $80.00 to fulfill her wish.

Once user A in the first layer receives her $80.00 to fulfill her wish, users B and C from the second layer will automatically become two independent tree pyramids. In other words, David and Tom will become the first layer of their own tree pyramid. The users from the third layer of user A's tree (users D, F, G, and H) then become the second layer of the trees of users B and C.

The users D, F, G, and H then broadcast their wishes to find or invite users for the third layer for user B and C's respective tree pyramids. Once the vacancies of third layer are filled, users B and C can each collect $80 for their goals/wishes. Users D, F, G, and H from the second layer of user B and C's trees now become the first layer of their own trees, and the process continues.

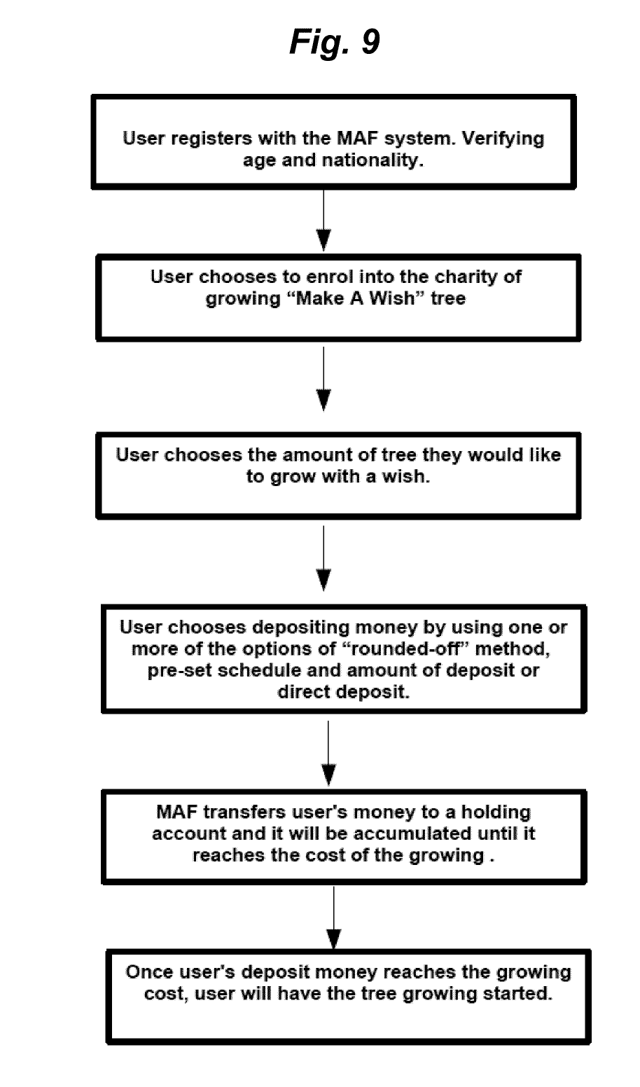

FIG. 9 is a flow diagram of a micro-accumulation multi-level donation aggregation process performed by an example embodiment. This process uses micro-accumulation methods to fund the donation aggregation techniques described above.

In implementation, the illustrated trees shown in FIG. 8 are implemented by way of specific data structures. The tree data structures have root nodes and children nodes. Different data structures may be used to support different donation models. For example, the example of FIG. 8 uses a binary tree model, but any branching factor (N) may be used. Also, while the above embodiment spawns new trees upon completion of a third level, in general, the completion of some other level number (e.g., level four, five) may be utilized as the trigger for spawning new trees.

Generalized Micro-Accumulation Method

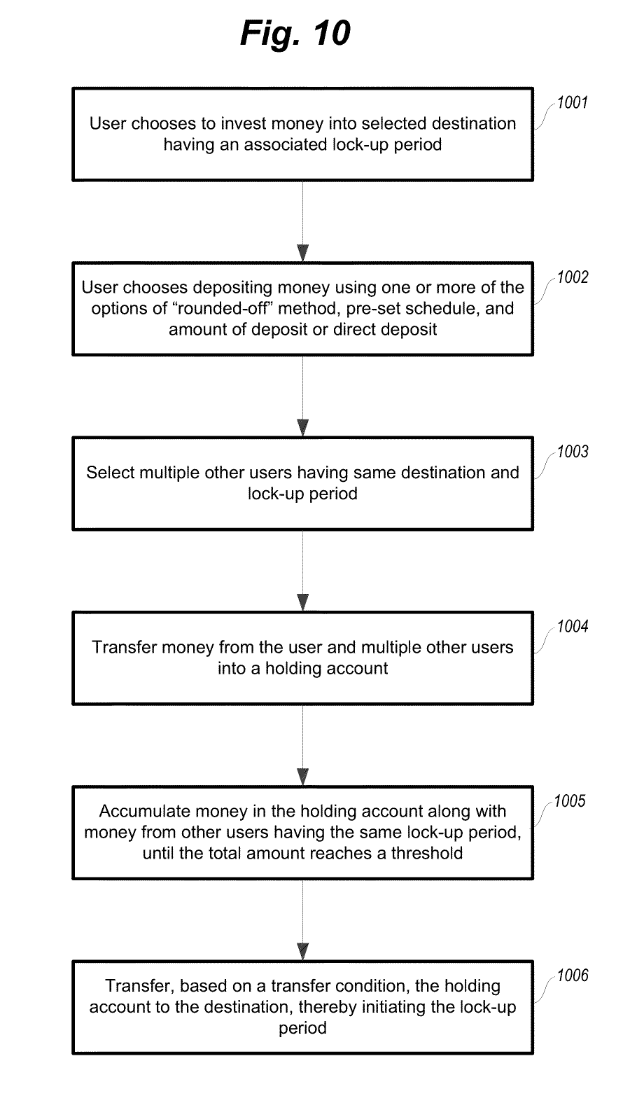

FIG. 10 is a flow diagram of a generalized micro-accumulation process according to an example embodiment. This figure generalizes the applications and enhancements to the micro-accumulation techniques described above. The process may be performed at least in part by the MAF system.

At block 1001, the user chooses to invest money into a selected destination having an associated lock-up period. The selected destination may be a hedge fund investment account, a betting portfolio, charity, or the like. The associated lock-up period is a term of time that may be specified or selected by the user, the destination service (e.g., hedge fund), or some other entity.

At block 1002, the user chooses one or more of the above describe accumulation techniques, including micro-accumulation, pre-set scheduled accumulation, direct deposit, or the like. Varying payment processing schemes are supported, including funds transfer, credit transaction, Internet payment systems, or the like.

At block 1003, the process (e.g., the MAF system) selects multiple other users having the same destination and lock-up period. The MAF system will typically have information about many users who have selected one or more of the different destinations offered by the MAF and the associated lock-up periods. The MAF system can then search the users to create a group or cohort of users that have expressed similar investment desires.

At block 1004, the MAF system transfers money from the user and the multiple other users into a holding account. Once a group or cohort of similar users is identified, a holding account is generated to track and accumulate funds for eventual transfer to the destination. In some cases, the user may be added to an already existing group. However, if the holding account associated with the group is already substantially full (e.g., near the threshold required for transfer to the destination), then the user may only accumulate a small share of the holding account by the time the transfer to the destination occurs (see below). The MAF system may employ various approaches to address this issue. In one solution, the MAF system utilizes an “entry window,” which is a specified time period (e.g., one day, three days, one week) during which new users may be added to an investment group, so that all users in the group are of roughly the same “age.” If those users save at the same or similar rates, they will all be entitled to roughly equal shares of the account.

In another solution, the MAF system allows a user to join an investment cohort at any time. When the holding account associated with that cohort reaches the threshold, the holding account is transferred to the destination, creating a first destination account. At that time, the MAF system creates a new, empty holding account associated with the cohort. Over time, this holding account accumulates funds (and new users) until it also reaches the threshold. At that time, the holding account is transferred to the destination, creating a second holding account. This process repeats, sequentially generating new destination accounts. At a given moment in time, each user is entitled to a share of each destination account based on the share of funds that user contributed to the corresponding holding account. Users can stop contributing at any time, thus eliminating any share from any destination accounts created after the one that originates based on the current holding account.

At block 1005, the process accumulates money in the holding account along with money from other users having the same lock-up period, until the total amount reaches a threshold. The threshold may be the minimum amount required by a hedge fund or other investment portfolio. In other cases, the threshold may be the threshold amount required to trigger the generation of a new donation tree.

At block 1006, the process transfers, based on a transfer condition, the holding account to the destination, thereby initiating the lock-up period. The transfer condition may include one or more conditions such as exceeding the required threshold amount for a given investment account, collecting the minimum donation from a specified number of other users, the passage of a certain amount of time, or the like.

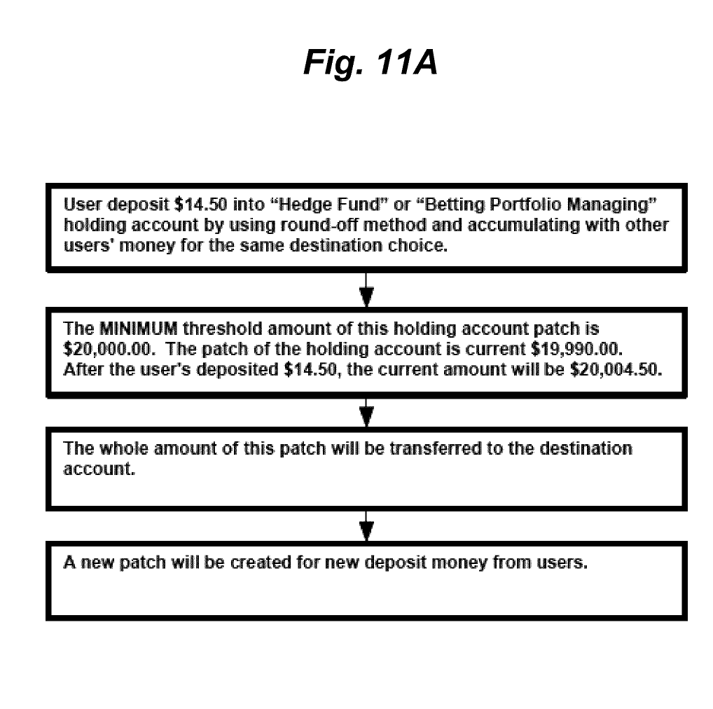

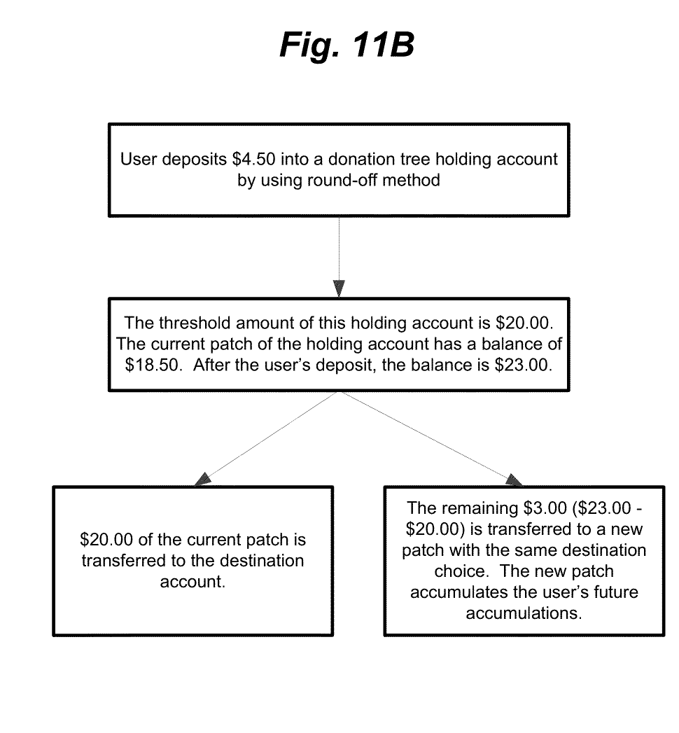

FIGS. 11A and 11B are flow diagrams of holding account fund accumulation processes according to an example embodiment. The illustrated process may be executed by, for example, the process of FIG. 10, or other processes that utilize holding accounts. The processes of FIGS. 11A and 11B each manage a distinct type of holding account.

The first type of holding account, illustrated with respect to FIG. 11A, has a minimum threshold amount. The minimum threshold account is used in some embodiments with respect to the hedge fund and betting portfolio applications. In this type of account, when the minimum threshold is reached or exceeded, all of the money in the holding account (“the patch”) is transferred to the destination account. Additional money deposited into the holding account (with the same destination) will be held and accumulated in a new patch until the corresponding threshold is reached or exceeded.

The second type of holding account, illustrated with respect to FIG. 11B, has an exact threshold amount. The exact threshold account is used in some embodiments with respect to the global lotto and donation aggregation applications. In this type of account, if deposited money causes the current patch amount to exceed the threshold, part of the deposited money will be transferred into the current patch in order to meet the exact threshold, and thence transferred to the destination account. The rest of the deposited money will be transferred to a new patch and keep accumulating along with future deposits.

The above-described techniques improve the field of fund aggregation. For example, the MAF system improves the functioning of computer systems in that a computer system that does not implement the MAF system is not capable of providing users access to a wide variety of investment and charity vehicles, and further to provide mechanisms for collecting funds targeted to those vehicles. The described techniques require more than generic computer operations to perform, because a generic computer is not configured to accumulate funds in the described manner, collect those funds in a holding account, and then transfer that holding account to a destination account upon the occurrence of a specified condition. Moreover, at least some embodiments perform unconventional steps that confine the described techniques to particular, useful applications, such as collecting money for charity in a multi-level tree, enabling a vast number of users to access investment vehicles (e.g., hedge funds) that are otherwise off limits due to wealth and income requirements, and the like.

All of the above U.S. patents, U.S. patent application publications, U.S. patent applications, foreign patents, foreign patent applications, non-patent publications, and appendixes referred to in this specification and/or listed in the Application Data Sheet are incorporated herein by reference, in their entireties.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

1. A method for accumulation and disbursement of micro-accumulation funds, the method comprising:
performing, by a micro-accumulation fund (“MAF”) system, the system comprising a user interface device, a data storage device, and a processor, the steps of:
receiving point-of-sale information relating to a purchase made by a user;
computing a round-off amount in accordance with a user-defined rounding value;
transferring the round-off amount to a holding account; and
transferring, based on a transfer condition, at least a portion of the holding account to a destination account.

2. The method of claim 1, further comprising:
determining whether the transfer condition has occurred, by determining whether the funds in the holding account exceed a predetermined threshold.

3. The method of claim 1, further comprising:
transferring an amount from a user-specified source that is one of a bank account, debit card, credit card, or an Internet payment system, wherein the transfer occurs at a scheduled interval.

4. The method of claim 1, further comprising:
receiving from the user an indication of a lock-up period;
selecting multiple other users that have indicated lock-up periods that are equivalent to the lock-up period indicated by the user; and
transferring round-off amounts based on transactions performed by the multiple other users into the holding account.

5. The method of claim 4, wherein the lock-in period is one of three months, six months, or one year.

6. The method of claim 4, further comprising:
prior to the transferring at least a portion of the holding account to the destination account, allowing the user to withdraw funds from the holding account.

7. The method of claim 4, further comprising:
after the transferring at least a portion of the holding account to the destination account, disallowing access to funds in the destination account during the lock-up period, wherein the lock-up period starts running upon the transferring at least a portion of the holding account to the destination account.

8. The method of claim 7, further comprising:
after the lock-up period runs, allowing the user to withdraw funds from the destination account, wherein the user is entitled to a pro-rata share of the destination account, based on the share of the user's funds in the holding account.

9. The method of claim 1, wherein the destination account is a hedge fund investment account, and further comprising:
receiving from the user an indication of the hedge fund investment account and a corresponding lock-up period;
selecting multiple other users that have also indicated the hedge fund investment account and the corresponding lock-up period;
transferring round-off amounts based on transactions performed by the multiple other users into the holding account;
prior to the transferring at least a portion of the holding account to the destination account, allowing the user to withdraw funds from the holding account; and
after the transferring at least a portion of the holding account to the destination account, disallowing access to funds in the hedge fund investment account during the lock-up period, wherein the lock-up period starts running upon the transferring at least a portion of the holding account to the destination account.

10. The method of claim 9, further comprising:
after the lock-up period runs, allowing the user to withdraw funds from the destination account, wherein the user is entitled to a pro-rata share of the destination account, based on the share of the user's funds in the holding account.

11. The method of claim 1, wherein the destination account is a betting investment account, and further comprising:
providing the user with information about multiple betting investment account and corresponding lock-up periods;
receiving from the user an indication of the betting investment account and a corresponding lock-up period;
selecting multiple other users that have also indicated the betting investment account and the corresponding lock-up period; and
transferring round-off amounts based on transactions performed by the multiple other users into the holding account.

12. The method of claim 11, further comprising:
prior to the transferring at least a portion of the holding account to the destination account, allowing the user to withdraw funds from the holding account; and
after the transferring at least a portion of the holding account to the destination account, disallowing access to funds in the hedge fund investment account during the lock-up period, wherein the lock-up period starts running upon the transferring at least a portion of the holding account to the destination account; and
after the lock-up period runs, allowing the user to withdraw funds from the destination account, wherein the user is entitled to a pro-rata share of the destination account, based on the share of the user's funds in the holding account.

13. The method of claim 1, wherein the destination account is a charity account, and further comprising:
managing a donation aggregation process and corresponding tree data structure having a root node and a branching factor of N;
associating the user with the root node of the tree data structure;
receiving indications of N second-level users;
associating each of the N second-level users with a corresponding child node of the root node; and
for each of the N second-level users, receiving indications of N third-level users and associating each of the N third-level users with a corresponding child node of the second-level user.

14. The method of claim 13, wherein the transfer condition occurs when N̂2 third level users have been identified, and further comprising:
upon occurrence of the transfer condition, transferring a donation amount associated with each of the N third-level users to the charity account.

15. The method of claim 14, further comprising:
upon occurrence of the transfer condition, creating N new trees, wherein each of the N second-level users becomes a root of one of the N new trees, and wherein each of the third-level users becomes a second level user associated with one of the N new trees; and
for each of the N second-level users of each of the N new trees, receiving indications of N third-level users and associating each of the N third-level users with a corresponding child node of the second-level user.

16. The method of claim 1, wherein the destination account is a lotto ticket purchase account, and further comprising:
selecting a first lotto game, the first lotto game administered in a target country;
managing a second lotto game that tracks rules and numbers drawn in the first lotto game;
transferring round-off amounts based on transactions performed by multiple other users into the holding account;
using funds from the destination account to purchase tickets in the first lotto game; and
when one of the tickets purchased in the first lotto game is a winning ticket,
distributing winnings received from the first lotto game to the user and the multiple other users; and
distributing a portion of the destination account to the user and the multiple other users.

17. The method of claim 1, further comprising:
determining whether the transfer condition has occurred, by determining whether at least a predetermined threshold number of distinct users have contributed to the holding account.

18. The method of claim 1 wherein:
the point-of-sale information comprises a purchase amount; and
computing a round-off amount comprises:
calculating a value X that is a lowest multiple of the user-defined rounding value such that X is greater than or equal to the purchase amount; and
subtracting the purchase amount from X to yield the round-off amount.

19. A computer system for accumulation and disbursement of micro-accumulation funds, the system comprising:
a processor; and
a memory storing instructions that are configured to:
receive from a user a selection of a destination investment that is one of a hedge fund investment, a betting investment, or a charity, wherein the destination investment has an associated lock-up period;
select multiple users having selected the destination investment with the associated lock-up period, wherein the user is one of the multiple users;
collect money based on round-off amounts determined with respect to point-of-sale purchases made by the multiple users;
accumulate the collected money into a holding account associated with the multiple users; and
upon occurrence of a transfer condition, transfer the holding account to the destination investment.

20. A non-transitory computer readable medium containing program instructions for accumulation and dispensation of micro-accumulation funds, wherein execution of the program instructions by at least one processor of a computer system causes the at least one processor to carry out the steps of:
receiving from a user a selection of a destination investment that is one of a hedge fund investment, a betting investment, or a charity, wherein the destination investment has an associated lock-up period;
selecting multiple users having selected the destination investment with the associated lock-up period, wherein the user is one of the multiple users;
collecting money based on round-off amounts determined with respect to point-of-sale purchases made by the multiple users;
accumulating the collected money into a holding account associated with the multiple users; and
upon occurrence of a transfer condition, transferring the holding account to the destination investment.
